(19) United States
(12) Patent Application Publication
(10) Pub. No.: US 2025/0363047 A1
(43) Pub. Date: Nov. 27, 2025

(54) Reducing allocated block storage on the fly

(71) Applicant: Datafy Ltd., Tel Aviv (IL)

(72) Inventors: Yoav Ilovich, Tel-Aviv (IL); Dan Cohen, Raanana (IL); Jacob Hanna, Rameh (IL)

(21) Appl. No.: 19/062,063

(22) Filed: Feb. 25, 2025

Related U.S. Application Data
(60) Provisional application No. 63/650,426, filed on May 22, 2024.

(51) Int. Cl. G06F 12/02

(52) U.S. Cl. CPC G06F 12/0246; G06F 2212/7202

(57) ABSTRACT

A method for use with at least one remote storage device includes, using a processor of a local device, intercepting messages from a file system running on the local device and directed to the remote storage device, the messages including write messages, which specify data to be written to block storage on the remote storage device allocated to a user account associated with the local device, and discard messages, which reference portions of the data no longer required by the file system. The method further includes, based on the messages, tracking a size of the data stored in the block storage and required by the file system, based on the tracking, determining that a capacity of the allocated block storage is excessive, relative to the size of the data, and in response to the capacity being excessive, reducing the capacity. Other embodiments are also described.

### CROSS-REFERENCE TO RELATED APPLICATIONS

The present application claims the benefit of U.S. Provisional Application 63/650,426, entitled “Seamless on-the-fly shrinking of an attached block device,” filed May 22, 2024, whose disclosure is incorporated herein by reference.

### FIELD OF EMBODIMENTS OF THE INVENTION

Embodiments of the present invention relate generally to data storage systems, and specifically to the allocation and usage of remote block storage volumes.

### BACKGROUND

Block storage volumes are a fundamental component of modern computer storage systems, providing a method for storing data in fixed-size blocks. Each block is identified by a unique address, allowing for efficient and direct access to data. Block storage is commonly used in various types of storage devices, including hard drives, solid-state drives, and storage area networks. This type of storage is highly versatile and can be used for a wide range of applications, from simple file storage to complex database management.

However, managing block storage volumes can be challenging, especially when it comes to optimizing storage utilization and ensuring efficient allocation of resources. Thin provisioning addresses this challenge, by dynamically allocating storage capacity as needed, rather than pre-allocating the entire storage space upfront. Thin provisioning allows for more efficient use of storage resources, reducing the need for over-provisioning and minimizing wasted space.

### SUMMARY

There is provided, in accordance with some embodiments of the present invention, a computer software product for use with at least one remote storage device, the computer software product including a tangible non-transitory computer-readable medium in which program instructions are stored. The instructions, when read by a processor of a local device, cause the processor to intercept messages from a file system running on the local device and directed to the remote storage device, the messages including write messages, which specify data to be written to block storage on the remote storage device allocated to a user account associated with the local device, and discard messages, which reference portions of the data no longer required by the file system. The instructions further cause the processor to track a size of the data stored in the block storage and required by the file system, based on the messages. The instructions further cause the processor to determine, based on the tracking, that a capacity of the allocated block storage is excessive, relative to the size of the data, and to reduce the capacity in response to the capacity being excessive.

In some embodiments, the remote storage device belongs to a cloud-computing platform.

In some embodiments, the program instructions include a driver.

In some embodiments, the instructions cause the processor to intercept the messages by interposing between the file system and a block device driver of the remote storage device.

In some embodiments, the instructions cause the processor to intercept the messages by interposing between a block device application program interface of the local device and the block device driver.

In some embodiments, the instructions further cause the processor to:
based on the tracking, determine that the capacity is insufficient, relative to the size of the data, and
in response to the capacity being insufficient, increase the capacity.

In some embodiments, the remote storage device does not support the discard messages, and the instructions further cause the processor to instruct the file system to issue the discard messages even though the remote storage device does not support the discard messages.

In some embodiments, the instructions further cause the processor to provision physical addresses in the remote storage device and to map logical addresses provided by the file system to the provisioned physical addresses, such that the block storage is thin provisioned.

In some embodiments, the remote storage device includes a solid state drive, and the discard messages include TRIM instructions.

In some embodiments, the instructions cause the processor to determine that the capacity is excessive in response to a difference between the capacity and the size of the data exceeding a predefined threshold.

In some embodiments, the instructions further cause the processor to compute a duration from a time at which the capacity was most recently increased, and the instructions cause the processor to reduce the capacity in response to the duration exceeding a predefined threshold.

In some embodiments, the instructions further cause the processor to refrain from reducing the capacity to less than a predefined threshold.

In some embodiments,
prior to the reduction of the capacity, a first range of physical addresses in the remote storage device are allocated to the user account,
the instructions further cause the processor to identify, based on the messages, those of the physical addresses at which the data required by the file system is stored, and
the instructions cause the processor to reduce the capacity by:
   allocating a second range of physical addresses, which is smaller than the first range, to the user account, and
   copying the data required by the file system from any of the identified physical addresses not in the second range to the second range.

In some embodiments, the at least one remote storage device includes a first storage disk including the first range of physical addresses and a second storage disk including the second range of physical addresses, such that the copying includes copying the data from the first storage disk to the second storage disk.

In some embodiments,
the at least one remote storage device includes multiple storage disks including the first range of physical addresses, and
a subset of the storage disks includes the second range of physical addresses, such that the copying includes copying the data from those of the storage disks not in the subset to the subset.

In some embodiments,
the at least one remote storage device includes a storage disk including the first range of physical addresses, and
a portion of the storage disk includes the second range of physical addresses, such that the copying includes copying the data from outside the portion of the storage disk to the portion of the storage disk.

There is further provided, in accordance with some embodiments of the present invention, a method for use with at least one remote storage device. The method includes, using a processor of a local device, intercepting messages from a file system running on the local device and directed to the remote storage device, the messages including write messages, which specify data to be written to block storage on the remote storage device allocated to a user account associated with the local device, and discard messages, which reference portions of the data no longer required by the file system. The method further includes, based on the messages, tracking a size of the data stored in the block storage and required by the file system. The method further includes, based on the tracking, determining that a capacity of the allocated block storage is excessive, relative to the size of the data, and in response to the capacity being excessive, reducing the capacity.

There is further provided, in accordance with some embodiments of the present invention, an apparatus for use with at least one remote storage device. The apparatus includes a memory and a processor configured to execute program instructions loaded into the memory so as to run a file system, to intercept messages from the file system and directed to the remote storage device, the messages including write messages, which specify data to be written to block storage on the remote storage device allocated to a user account associated with the processor, and discard messages, which reference portions of the data no longer required by the file system, to track a size of the data stored in the block storage and required by the file system based on the messages, to determine, based on the tracking, that a capacity of the allocated block storage is excessive, relative to the size of the data, and to reduce the capacity in response to the capacity being excessive.

The present invention will be more fully understood from the following detailed description of embodiments thereof, taken together with the drawings, in which:

### BRIEF DESCRIPTION OF THE DRAWINGS

FIG. 1 is a schematic illustration of a system for efficient remote block storage, in accordance with some embodiments of the present invention;

FIG. 2 is a flow diagram for a method for managing an allocated block-storage capacity, in accordance with some embodiments of the present invention; and

FIGS. 3A, 3B, and 3C are schematic illustrations of a reduction of the capacity of a block storage volume, in accordance with some embodiments of the present invention.

### DETAILED DESCRIPTION

### Overview

Some providers, such as cloud-computing platforms, offer remote block storage, whereby, after a user opens an account with the provider, any “local device” associated with the account (e.g., any local device logged into the account) can store data in a remote block storage volume allocated to the account by the provider. The block storage volume can span any number of devices including any number of storage disks, such as solid-state drives.

Some remote block storage applications use thin provisioning, whereby logical block addresses in the logical address space of the file system of the local device are mapped to physical block addresses in the storage volume on an as-need basis. As a result of the thin provisioning, the physical size of the storage volume can be significantly smaller than the logical size of the address space.

However, even with thin provisioning, the physical size of the storage volume can be larger than necessary, leading to inefficient use of resources and needlessly-high costs to the user. For example, if the storage volume has a size of 50 GB but only 20 GB of data are stored on the storage volume, 30 GB of storage capacity are wasted. Unfortunately, most conventional file systems-even those that support thin provisioning-do not support reducing the allocated storage capacity. Moreover, even those file systems that support this function, such as those with integrated volume managers, tend to be complicated and to suffer from poor performance.

To address this challenge, embodiments of the present invention provide a driver (or any other suitable piece of software) configured to reduce the allocated storage capacity whenever such a reduction is warranted. Advantageously, the capacity reduction is performed on the fly, without downtime to the file system or to the applications running on the local device, and without any changes to the logical address space of the file system.

To track the amount of utilized storage, the driver monitors the write and discard messages sent from the local file system to the remote block device. In particular, each write message specifies data to be written to the remote device, such that the driver computes an increase in the utilized storage—the size of the increase being equal to the size of the specified data—in response to the write message. Conversely, each discard message, such as a TRIM instruction issued to a solid-state drive, references the stored data no longer required by the file system, such that the driver computes a decrease in the utilized storage—the size of the decrease being equal to the size of the referenced data—in response to each discard message. In response to the utilized storage being significantly less than the allocated capacity, the driver reduces the allocated capacity, e.g., by allocating a smaller disk and copying the stored data to the smaller disk.

Thus, advantageously, the driver does not need to be integrated with the file system; for example, the file system does not even need to know that the driver exists. Moreover, typically, the driver is also configured to facilitate thin provisioning of the remote storage volume by providing the required logical-to-physical indirection layer, such that the driver can be used even with common file systems that do not support thin provisioning. In such embodiments, in addition to monitoring the write and discard messages, the driver maps the logical addresses specified in these messages to physical addresses in the remote storage volume.

Typically, even if the remote device does not support discard messages, the driver instructs the file system to issue such messages, i.e., the driver tricks the file system into believing that the remote device supports the discard functionality. Thus, advantageously, in addition to being compatible with any file-system implementation, the driver is compatible with any block-storage implementation.

### System Description

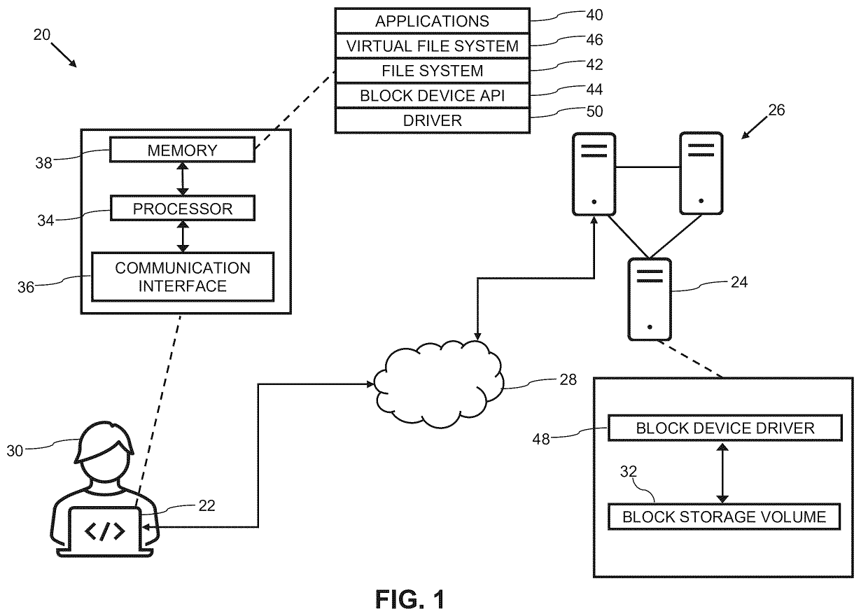

Reference is now made to FIG. 1, which is a schematic illustration of a system 20 for efficient remote block storage, in accordance with some embodiments of the present invention.

System 20 comprises a local device 22, which may be used by a user 30, and at least one remote storage device 24, such as at least one storage disk residing on at least one server (as depicted in FIG. 1) and/or at least one standalone storage disk. In some embodiments, remote storage device 24 belongs to a cloud-computing platform 26. Remote device 24 is networked with local device 22 over a network 28, such as the Internet. A block storage volume 32 on remote device 24 is allocated, for storage of data, to a user account associated with local device 22 (e.g., by virtue of user 30 having logged into the user account), and local device 22 stores data in block storage volume 32. In some embodiments, block storage volume 32 includes a solid state drive (SSD).

Local device 22 comprises a processor 34, a communication interface 36, and a memory 38, such as a random access memory. Processor 34 is configured to exchange communication with remote device 24 via communication interface 36. Processor 34 is further configured to execute program instructions loaded into memory 38, including instructions for the execution of applications 40. For any application 40 that reads from or writes to block storage volume 32, a file system 42 (e.g., of type XFS™ or Ext4™), which is run by processor 34 on local device 22, interfaces between the application and the block device application programming interface (API) 44. Typically, a virtual file system 46 provides a layer of abstraction between applications 40 and file system 42.

In conventional remote block storage, block device application programming interface 44 interfaces directly with the block device driver 48 on remote device 24, which performs the low-level read and write operations on block storage volume 32. In some embodiments of the present invention, on the other hand, a driver 50 (or any other suitable piece of software) interposes between block device application programming interface 44 and block device driver 48. Alternatively, driver 50 otherwise interposes between file system 42 and block device driver 48, e.g., by interposing between file system 42 and block device application programming interface 44. Thus, by executing driver 50, processor 34 intercepts messages issued by the file system and directed to the remote device 24. Based on these messages, the processor manages the capacity of the allocated block storage, as further described below with reference to the subsequent figures.

Typically, by executing driver 50, the processor also provisions physical addresses in storage device 24 and maps logical addresses provided by the file system to the provisioned physical addresses, such that the block storage on device 24 is thin provisioned. The metadata for this mapping can be stored on local device 22 or on remote device 24, e.g., at the head of the block storage volume.

In some embodiments, by executing driver 50, the processor also logically concatenates block storage volume 32 with a boot volume that is not thin-provisioned, as described in co-assigned U.S. application Ser. No. 19/000,780. In particular, the processor maps any logical address provided by the file system and less than the size of the boot volume to an equivalent physical address in the boot volume, and maps other logical addresses provided by the file system to provisioned physical addresses in block storage volume 32, as described above.

In general, processor 34 may be embodied as a single processor, or as a cooperatively networked or clustered set of processors. The functionality of processor 34 described herein is typically implemented in software. For example, processor 34 may be embodied as a programmed processor comprising, for example, a central processing unit (CPU) and/or a Graphics Processing Unit (GPU). Program instructions, including software program instructions, and/or data may be loaded for execution and processing by the CPU and/or GPU. The program instructions and/or data may be downloaded to the processor in electronic form, over a network, for example. Alternatively or additionally, the program instructions and/or data may be provided and/or stored on non-transitory tangible media, such as magnetic, optical, or electronic memory. Such program instructions and/or data, when provided to the processor, produce a machine or special-purpose computer, configured to perform the tasks described herein.

### Managing the Block-Storage Capacity

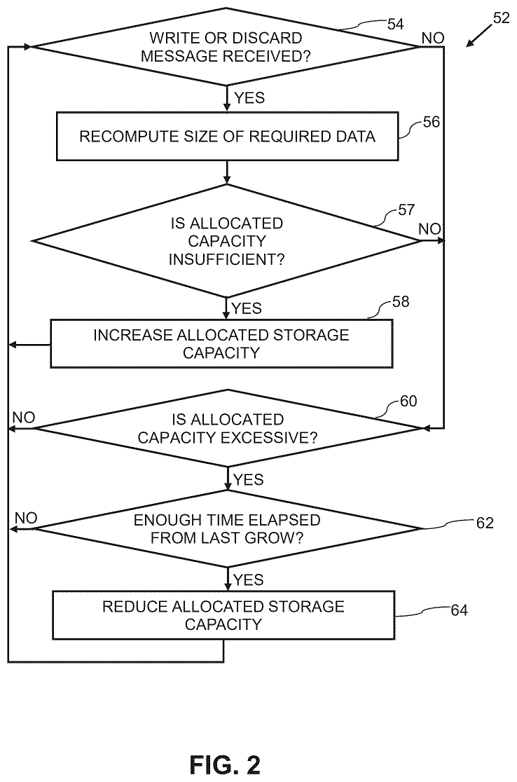

Reference is now additionally made to FIG. 2, which is a flow diagram for a method 52 for managing an allocated block-storage capacity, in accordance with some embodiments of the present invention. Method 52 is performed by processor 34 in the execution of driver 50 or any other suitable set of program instructions.

In performing method 52, the processor tracks the size of data that is stored in the block storage allocated to the user account associated with local device 22 and is required by file system 42. The processor performs this tracking based on messages from file system 42, which the processor intercepts by virtue of interposing between the file system and the remote device as described above. The messages include write messages, which specify data to be written to the remote block storage (along with, typically, the logical addresses to which the data is to be written), and discard messages, which reference portions of the data no longer required by the file system (typically, by specifying the logical addresses at which the no-longer-needed portions of data are stored). An example of a discard message is a TRIM instruction, which is issued by the file system to notify a solid state drive (SSD) of any addresses that were logically deleted by the file system, thus increasing the efficiency of the SSD garbage-collection process.

In particular, at a checking step 54, the processor checks whether a write or discard message was received. If yes, the processor, at a size-recomputing step 56, recomputes the size of the stored data required by the file system, based on the size of the write or discard operation. In other words, for each write message, the processor ascertains the size of the data to be written, and adds this size to the running total size, designated herein as S. For example, in some embodiments, each write message includes a field explicitly indicating the size of the data, and the processor extracts this field from the message. Alternatively, the processor computes the size of the data, e.g., based on the list of logical addresses specified in the message. Conversely, for each discard message, the processor computes the size of the data referenced in the message, e.g., based on the list of logical addresses specified in the message, and subtracts this size from S.

In some cases, remote storage device 24 does not support discard messages, i.e., the remote storage device does not recognize, or know what to do with, these messages. In such cases, the processor instructs the file system to issue the discard messages nonetheless, by issuing any, suitable command such as the fstrim command on Linux™ platforms.

In some embodiments, following size-recomputing step 56, the processor checks, at a checking step 57, whether the capacity C of the allocated block storage is insufficient relative to S, e.g., by checking whether C−S is less than a predefined threshold. If yes, the processor increases the capacity at a capacity-increasing step 58, e.g., by allocating another storage disk and appending the disk to the current storage disk(s). Subsequently, the processor returns to checking step 54.

On the other hand, if C is not insufficient, the processor checks, at a checking step 60, whether C is excessive relative to S. If not, the processor returns to checking step 54. Otherwise, in response to determining that C is excessive relative to S, the processor reduces the allocated storage capacity at a capacity-reducing step 64, as further described below. Typically, however, the processor first checks, at a checking step 62, whether the duration from the time at which the allocated capacity was most recently increased (i.e., the time of the most recent “grow” operation) exceeds a predefined threshold, such as one hour for example. If not, the processor returns to checking step 54. (Checking step 62 thus helps avoid disruptive back-and-forth oscillations in the capacity.) Subsequently, even if no new write or delete messages are received, the processor may check, at checking step 60, whether the allocated capacity was previously determined to be excessive, and if so, re-execute checking step 62.

On the other hand, in response to the duration exceeding the predefined threshold, the processor performs capacity-reducing step 64. Typically, at this step, the processor reduces the allocated capacity to S+b, where b is a suitable size buffer. In some embodiments, b is specified as an absolute number. Alternatively, the processor computes b as p1*S, where p1 is a predefined percentage, such as 15%. For cases in which it is not feasible to reduce the capacity to S+b, such as cases in which the allocated capacity must be a multiple of a particular number, the processor reduces the allocated capacity to the smallest allowable size greater than S+b. For example, for cases in which each storage disk has a size of 20 GB, and a storage disk can be either allocated entirely or not at all, the processor may reduce the allocated capacity from 40 GB (two disks) to 20 GB (one disk) in response to S+b equaling 15 GB.

Typically, at checking step 60, the processor checks whether the difference between C and S exceeds a predefined threshold. For example, in some embodiments, the processor computes C
S, and compares this quantity to a predefined threshold. Alternatively, the processor implicitly compares C−S to a predefined threshold T+b by computing C−(S+b), which is the size of the potential reduction in the capacity, and comparing this quantity to a predefined threshold T. The processor thus avoids excessively small reductions in capacity, which provide relatively little benefit; for example, if T=10 GB, the processor avoids reductions that are less than 10 GB. In some embodiments, T is specified as an absolute number. In other embodiments, the processor computes T as p2*C, where p2 is a predefined percentage, such as 10%. Alternatively, the processor considers the capacity excessive only if C−(S+b) exceeds two thresholds: a threshold T1, which is specified as an absolute number (e.g., 10 GB), and another threshold T2, which is computed as p2*C.

For example, it will be assumed that the capacity C is 50 GB, the size S of the data is 20 GB, the size buffer b is 10 GB, T is 15 GB, and p2 is 10%. In this case, the processor may check whether to reduce the capacity by (i) comparing C−S=30 GB to a predefined threshold larger than T, such as 25 GB, (ii) comparing C−(S+b)=20 GB to T=15 GB, or (iii) comparing C−(S+b)=20 GB to T=15 GB and to 10%*50=5 GB. In response to the threshold(s) being exceeded, the processor may reduce the capacity to S+b=30 GB.

In some embodiments, the processor refrains from reducing the capacity to less than a predefined threshold M, such as 25 GB for example, since it is assumed that excessively-small capacities are typically not sustainable. For example, in some embodiments, at checking step 60, the processor compares min (C−M, C−(S+b)) to T (or to the two thresholds T1 and T2). In response to the former exceeding the latter, the processor reduces the capacity to max (M, S+b).

For example, it will be assumed that the capacity C is 50 GB, the size S of the data is 20 GB, the size buffer b is 10 GB, Tis 15 GB, and M is 25 GB. In this case, the processor may check whether to reduce the capacity by comparing min (C-M=25 GB, C−(S+b)=20 GB)=20 GB to T=15 GB. In response to the threshold being exceeded, the processor may reduce the capacity to max (M=25 GB, S+b=30 GB)=30 GB. On the other hand, if S were 10 GB, the capacity would be reduced to max (M=25 GB, S+b=20 GB)=25 GB.

Typically, based on the write and discard messages, the processor identifies the physical addresses in the remote storage device at which the data required by the file system is stored. For example, for embodiments in which the processor implements thin provisioning, this identification is straightforward: for every logical address specified in these messages, the processor looks up the corresponding physical address to which the logical address is mapped (or, in the case of a write message, provisions the corresponding physical address if this has not yet been done). During capacity-reducing step 64, the processor allocates a range of physical addresses to the user account, this range being smaller than the previous range allocated to the account. The processor then copies the data required by the file system from any of the identified physical addresses not in the newly-allocated range to the newly-allocated range. In some embodiments, the processor then deletes the copied data from the original addresses at which the copied data was stored.

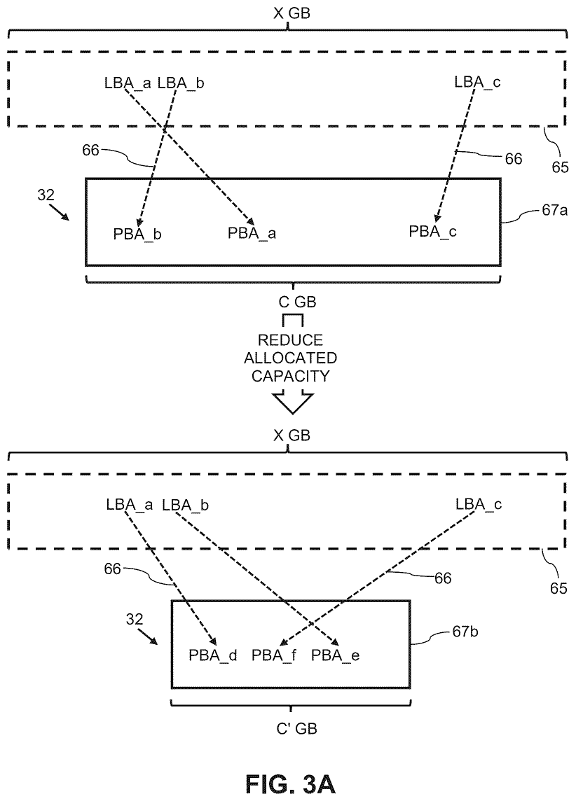

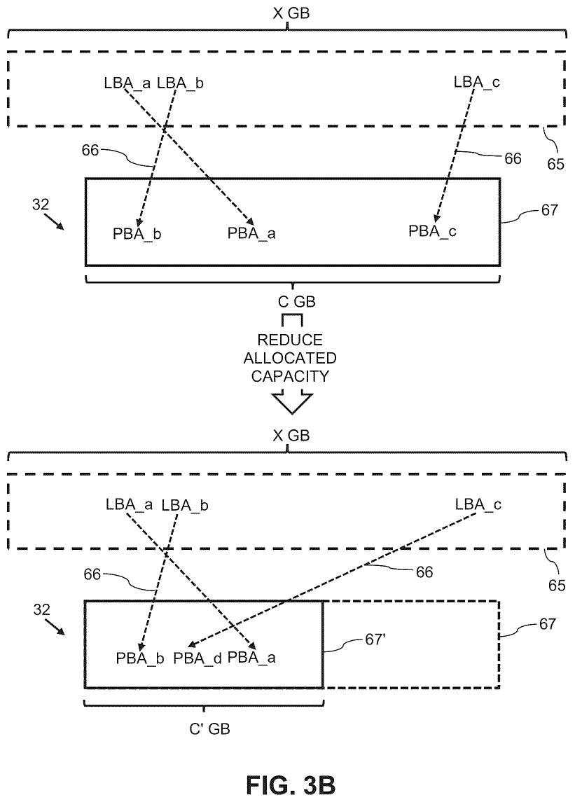

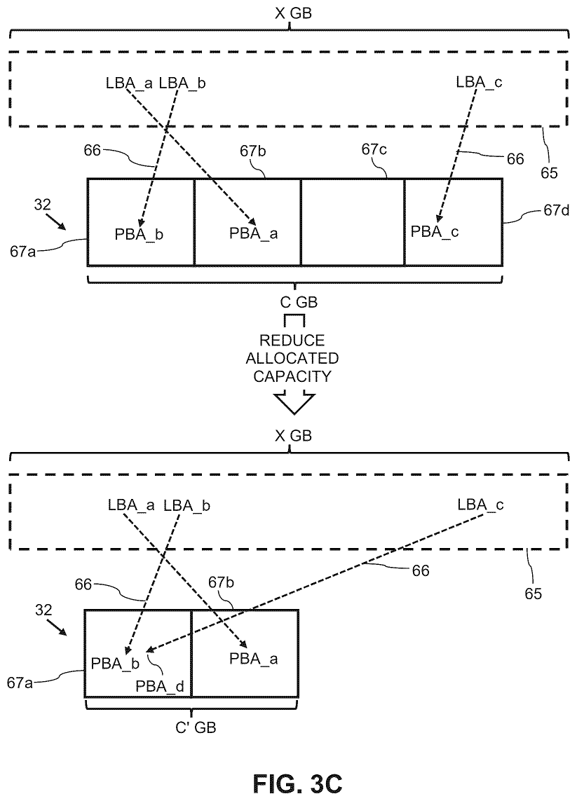

For further details in this regard, reference is now made to FIG. 3A, which is a schematic illustration of a reduction of the capacity of block storage volume 32, in accordance with some embodiments of the present invention.

The top of FIG. 3A shows storage volume 32 residing on a first storage disk 67a. Logical address space 65 of the file system, which has a size of X GB, is mapped to a first range of physical addresses on first storage disk 67a, this range having a size of C GB. By way of example, three logical block addresses LBA_a, LBA_b, and LBA_c are shown mapped to respective physical block addresses PBA_a, PBA_b, and PBA_c in storage disk 67a, as indicated by mapping indicators 66. By virtue of the mapping from logical address space 65 to the physical addresses in the storage disk, the storage disk is thin-provisioned, such that, advantageously, the user obtains X GB of logical space for data storage with only C<X GB of physical space. As described above with reference to FIG. 1, typically, driver 50, which manages the capacity of the block storage volume, also manages the mapping from logical address space 65 to the physical addresses in the storage volume.

In some embodiments, to reduce the allocated capacity at capacity-reducing step 64, the processor allocates a second storage disk 67b having a reduced capacity C′ GB, and copies the required data from first storage disk 67a to second storage disk 67b. The bottom of FIG. 3A shows the mapping of logical address space 65 to the smaller range of physical addresses in storage disk 67b following this operation. By way of example, the bottom of FIG. 3A shows the data at PBA_a copied to PBA_d, the data at PBA_b copied to PBA_e, and the data at PBA_c copied to PBA_f. Advantageously, there is no reduction in logical address space 65, and the file system does not need to know of the changes to the block storage volume.

Reference is now made to FIG. 3B, which is a schematic illustration of a reduction of the capacity of block storage volume 32, in accordance with other embodiments of the present invention.

In some embodiments, rather than allocating another, smaller storage disk as in FIG. 3A, the processor allocates a portion 67′ of the original storage disk 67, and then copies the required data from outside portion 67′ to portion 67′. Data that is already stored in portion 67′, on the other hand, can remain in place. The bottom of FIG. 3B shows logical address space 65 mapped to the smaller range of physical addresses in portion 67′. By way of example, the bottom of FIG. 3B shows the data at PBA_c copied to PBA_d, and the data at PBA_a and PBA_b remaining in place. (The top of FIG. 3B, showing the mapping prior to the capacity reduction, is the same as in FIG. 3A.)

Reference is now made to FIG. 3C, which is a schematic illustration of a reduction of the capacity of block storage volume 32, in accordance with yet other embodiments of the present invention.

In some embodiments, storage volume 32 resides on multiple storage disks. In some such embodiments, to reduce the capacity of the storage volume, the processor allocates a subset of the storage disks, and then copies the required data from those of the storage disks not in the subset to the subset.

For example, the top of FIG. 3C shows logical address space 65 mapped to the range of physical addresses spanning storage disks 67a, 67b, 67c, and 67d. Following the reduction in capacity, as shown at the bottom of FIG. 3C, all the data is stored on the first two of these storage disks. For example, the data at PBA_c, which belongs to storage disk 67d, is copied to PBA_d, which belongs to storage disk 67a.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer software product for use with at least one remote storage device, the computer software product comprising a tangible non-transitory computer-readable medium in which program instructions are stored, which instructions, when read by a processor of a local device, cause the processor to:
intercept messages from a file system running on the local device and directed to the remote storage device, the messages including write messages, which specify data to be written to block storage on the remote storage device allocated to a user account associated with the local device, and discard messages, which reference portions of the data no longer required by the file system,
based on the messages, track a size of the data stored in the block storage and required by the file system,
based on the tracking, determine that a capacity of the allocated block storage is excessive, relative to the size of the data, and
in response to the capacity being excessive, reduce the capacity.

2. The computer software product according to claim 1, wherein the remote storage device belongs to a cloud-computing platform.

3. The computer software product according to claim 1, wherein the program instructions include a driver.

4. The computer software product according to claim 1, wherein the instructions cause the processor to intercept the messages by interposing between the file system and a block device driver of the remote storage device.

5. The computer software product according to claim 4, wherein the instructions cause the processor to intercept the messages by interposing between a block device application program interface of the local device and the block device driver.

6. The computer software product according to claim 1, wherein the instructions further cause the processor to:
based on the tracking, determine that the capacity is insufficient, relative to the size of the data, and
in response to the capacity being insufficient, increase the capacity.

7. The computer software product according to claim 1, wherein the remote storage device does not support the discard messages, and wherein the instructions further cause the processor to instruct the file system to issue the discard messages even though the remote storage device does not support the discard messages.

8. The computer software product according to claim 1, wherein the instructions further cause the processor to provision physical addresses in the remote storage device and to map logical addresses provided by the file system to the provisioned physical addresses, such that the block storage is thin provisioned.

9. The computer software product according to claim 1, wherein the remote storage device includes a solid state drive, and wherein the discard messages include TRIM instructions.

10. The computer software product according to claim 1, wherein the instructions cause the processor to determine that the capacity is excessive in response to a difference between the capacity and the size of the data exceeding a predefined threshold.

11. The computer software product according to claim 1, wherein the instructions further cause the processor to compute a duration from a time at which the capacity was most recently increased, and wherein the instructions cause the processor to reduce the capacity in response to the duration exceeding a predefined threshold.

12. The computer software product according to claim 1, wherein the instructions further cause the processor to refrain from reducing the capacity to less than a predefined threshold.

13. The computer software product according to claim 1,
wherein, prior to the reduction of the capacity, a first range of physical addresses in the remote storage device are allocated to the user account,
wherein the instructions further cause the processor to identify, based on the messages, those of the physical addresses at which the data required by the file system is stored, and
wherein the instructions cause the processor to reduce the capacity by:
allocating a second range of physical addresses, which is smaller than the first range, to the user account, and
copying the data required by the file system from any of the identified physical addresses not in the second range to the second range.

14. The computer software product according to claim 13, wherein the at least one remote storage device includes a first storage disk including the first range of physical addresses and a second storage disk including the second range of physical addresses, such that the copying includes copying the data from the first storage disk to the second storage disk.

15. The computer software product according to claim 13,
wherein the at least one remote storage device includes multiple storage disks including the first range of physical addresses, and
wherein a subset of the storage disks includes the second range of physical addresses, such that the copying includes copying the data from those of the storage disks not in the subset to the subset.

16. The computer software product according to claim 13,
wherein the at least one remote storage device includes a storage disk including the first range of physical addresses, and
wherein a portion of the storage disk includes the second range of physical addresses, such that the copying includes copying the data from outside the portion of the storage disk to the portion of the storage disk.

17. A method for use with at least one remote storage device, the method comprising:
using a processor of a local device, intercepting messages from a file system running on the local device and directed to the remote storage device, the messages including write messages, which specify data to be written to block storage on the remote storage device allocated to a user account associated with the local device, and discard messages, which reference portions of the data no longer required by the file system;
based on the messages, tracking a size of the data stored in the block storage and required by the file system;
based on the tracking, determining that a capacity of the allocated block storage is excessive, relative to the size of the data; and
in response to the capacity being excessive, reducing the capacity.

18. The method according to claim 17, wherein the remote storage device does not support the discard messages, and wherein the method further comprises instructing the file system to issue the discard messages even though the remote storage device does not support the discard messages.

19. The method according to claim 17, further comprising provisioning physical addresses in the remote storage device and mapping logical addresses provided by the file system to the provisioned physical addresses, such that the block storage is thin provisioned.

20. An apparatus for use with at least one remote storage device, the apparatus comprising:
a memory; and
a processor configured to execute program instructions loaded into the memory so as to:
run a file system,
intercept messages from the file system and directed to the remote storage device, the messages including write messages, which specify data to be written to block storage on the remote storage device allocated to a user account associated with the processor, and discard messages, which reference portions of the data no longer required by the file system,
based on the messages, track a size of the data stored in the block storage and required by the file system,
based on the tracking, determine that a capacity of the allocated block storage is excessive, relative to the size of the data, and
in response to the capacity being excessive, reduce the capacity.
